(19) United States
(12) Patent Application Publication
(10) Pub. No.: US 2024/0189889 A1
(43) Pub. Date: Jun. 13, 2024

(54) REFRACTORY ARTICLE AND COMPOSITION

(71) Applicant: FOSECO INTERNATIONAL LIMITED, Derbyshire (GB)

(72) Inventors: Laura GRANA-SUAREZ, Enschede (NL); Michael KUBIAK, Mülheim an der Ruhr (DE); Frank VOSSEBELD, Haaksbergen (NL)

(21) Appl. No.: 18/555,568

(22) PCT Filed: Apr. 14, 2022
(86) PCT No.: PCT/EP2022/060119

§ 371 Date: Oct. 16, 2023

(30) Foreign Application Priority Data
Apr. 16, 2021 (EP) 21168913.8

(51) Int. Cl. B22C 9/08; C04B 33/13; C04B 33/32; C04B 35/14; C04B 35/18; C04B 35/63; C04B 35/65

(52) U.S. Cl. CPC B22C 9/088; C04B 33/131; C04B 33/1315; C04B 33/32; C04B 35/14; C04B 35/18; C04B 35/6303; C04B 35/651; C04B 2235/3272; C04B 2235/3418; C04B 2235/3463; C04B 2235/349; C04B 2235/402; C04B 2235/405; C04B 2235/428; C04B 2235/443; C04B 2235/445; C04B 2235/448; C04B 2235/9676

(57) ABSTRACT

There is provided a refractory article for use in metal casting and a composition for manufacture thereof, comprising a particulate refractory material, an oxidisable fuel, an oxidant, a sensitizer; a binder, and from 0.5 to 5 wt % CaSO₄.

### TECHNICAL FIELD OF THE INVENTION

The present invention relates to a refractory article for use in metal casting and a composition for use in manufacturing the refractory article. In particular, the present invention relates to a fluorine-free composition and refractory article, for example a feeder sleeve, for use in metal casting.

### BACKGROUND OF THE INVENTION

In a typical casting process, molten metal is poured into a pre-formed mould cavity that defines the shape of the casting. As the molten metal cools and solidifies, it shrinks, resulting in shrinkage cavities which in turn result in unacceptable imperfections in the final casting. This is a well-known problem in the casting industry and is addressed by the use of feeders or risers which are integrated into the mould. Each feeder provides an additional (usually enclosed) volume or cavity which is in communication with the mould cavity, so that molten metal enters into the feeder cavity from the mould cavity during casting. During solidification of the casting, molten metal within the feeder cavity flows back into the mould cavity to compensate for the shrinkage of the casting.

In order to successfully feed the casting and fill any voids created during shrinkage of the metal, the metal held within the feeder cavity must remain molten for a longer period than the metal in the mould cavity. For this reason, feeders are usually provided with a feeder sleeve made from a highly insulating refractory material, which reduces heat loss from the metal within the feeder cavity and helps it to stay molten for longer. Exothermic feeder sleeves may also be provided, which actively heat the metal within the feeder cavity.

Exothermic sleeves make use of a thermite reaction, in which an oxidisable fuel (usually a metal such as aluminium) is oxidised by an oxidant (typically iron oxide, manganese dioxide, potassium nitrate or a combination thereof) to generate heat at similar temperatures to the molten metal. The thermite reaction is initiated by the heat of the molten metal when it enters the feeder cavity and comes into contact with the fuel and oxidant.

Exothermic feeder sleeves are advantageous in that they permit the use of much smaller feeders for a given feeding application or type of casting. This has benefits in terms of reducing the amount of metal wasted in the feeder, the complexity of castings which can be produced and the number of castings which can be produced per mould. Over the years, significant effort has been expended on optimising exothermic feeder sleeves. The key parameters which are generally considered when evaluating new exothermic sleeves are the ignition time, the maximum temperature achieved (Tₘₐₓ) and the duration of the exothermic reaction (burn time). Increasing the quantity of fuel and/or oxidant does not necessarily increase the duration of the exothermic reaction. In many cases, not all of the fuel is consumed, and so increasing the fuel or oxidant loading may not be economical or practical. In order to improve the efficiency of exothermic sleeves, sensitizers or initiators have been developed, which lower the energy required to initiate the exothermic thermite reaction.

Fluoride-based initiators/sensitizers, such as potassium cryolite (K₃AlF₆) and sodium cryolite (NasAlF₆), are used extensively in the foundry industry and are acknowledged to be the most effective and practical sensitizers. However, there are environmental and technical issues caused by fluoride-containing sleeve residues contaminating the mould sand. Foundries are facing increasing problems with the disposal of waste sand containing fluoride residues both in the dry waste and the water leachable component, resulting in higher costs for controlled disposal. Another issue is that a build-up of fluoride residues in recirculated moulding sand leads to a reduction in the refractoriness of the sand and formation of casting surface defects (known as “fish eye”).

U.S. Pat. No. 6,360,808 discloses a composition wherein reduced fluoride levels are achieved by using aluminium dross as both the aluminium and fluoride source. US2009/0199991A1 discloses compositions containing metallocenes that may enable fluoride levels to be reduced. U.S. Pat. No. 5,180,759 discloses the use of a fluorinated organic polymer to reduce the overall fluoride content of the exothermic composition. EP1543897B1 and U.S. Pat. No. 6,972,059B1 both disclose fluoride-free compositions that use magnesium as the initiator which, due to its high reactivity, may cause difficulties in the manufacture and processing of exothermic mixtures. CA974764 discloses a hot topping composition which reacts to form a protective cover over the exposed surface of cast ingots. CN106631051 discloses refractory bricks or wall tiles for use as fireproof insulation and compositions for producing them. RU2163579 discloses a composition for an exothermic mortar for use in making refractory walls.

For feeder sleeves manufactured by a slurry route, it is difficult to find a technically feasible alternative to fluoride sensitizers, due to the need to use insoluble materials. Potential alternatives to insoluble fluoride salts, such as certain group Il chlorides, may exhibit the necessary insolubility but are known to be less effective sensitizers and cannot meet the necessary performance requirements.

The present invention has been developed with these issues in mind.

### SUMMARY OF THE INVENTION

According to a first aspect of the present invention there is provided a composition for making a refractory article for use in metal casting. The composition comprises a particulate refractory material, an oxidisable fuel, an oxidant, a sensitizer and a binder. The composition comprises from 0.5 to 5 wt % CaSO₄.

In some embodiments, the refractory composition comprises from 0.5 to 3 wt % or from 1 to 2 wt % CaSO₄.

The composition of the present invention comprises calcium sulfate (CaSO₄), which acts primarily as a sensitizer and also as an oxidant. The use of CaSO₄ as a sensitizer reduces the ignition time and/or increases the burn efficiency of the exothermic thermite reaction, such that the use of fluoride sensitizers can be reduced or eliminated. Decreasing the amount of fluoride sensitizer reduces fluorine contamination in the moulding sand, thereby mitigating environmental and cost issues associated with disposal of fluorine-contaminated sand and preventing build-up of fluorine in recirculated moulding sand, which may cause casting defects. In some embodiments, the composition comprises an oxidant and/or a sensitizer in addition to calcium sulphate.

It will be understood that, in the context of the present invention, the terms “sensitizer” and “initiator” may be used interchangeably and are used to refer to a substance which lowers the energy required to initiate an exothermic thermite reaction

In some embodiments, the composition comprises no more than 4.0 wt %, no more than 3.5 wt %, no more than 3 wt %, no more than 2.5 wt %, no more than 2 wt %, no more than 1.5 wt %, no more than 1.25 wt %, nor more than 1.0 wt %, no more than 0.5 wt %, or no more than 0.25 wt % of a sensitizer which is not calcium sulphate.

In some embodiments, the composition comprises no more than 4.0 wt %, no more than 3.5 wt %, no more than 3 wt %, no more than 2.5 wt %, no more than 2 wt %, no more than 1.5 wt %, no more than 1.25 wt %, nor more than 1.0 wt %, no more than 0.5 wt %, no more than 0.4 wt %, no more than 0.3 wt %, no more than 0.2 wt % fluorine, no more than 0.1 wt % or no more than 0.05 wt % fluorine. In some embodiments, the composition is substantially fluorine-free, i.e. containing no more than trace amounts of fluorine. Since fluorine compounds can be undesirable for casting quality and environmental reasons it is preferable for the composition to contain as little fluorine as possible while still maintaining desired characteristics of the thermite reaction.

In a preferred series of embodiments, the composition comprises a fluorine compound which is insoluble in water. In some embodiments, the composition comprises no fluorine, or substantially no fluorine, which is water soluble. The inventors have discovered that water-insoluble fluorine compounds can also act as sensitizers. Water-insoluble fluorine compounds are particularly desirable, since they do not contaminate mould sands with fluorine (or fluorine compounds) during reclamation of mould sands e.g. after use in a metal casting process of a refractory article formed from the composition.

In a preferred series of embodiments, the sensitizer may comprise calcium fluoride (CaF₂). Calcium fluoride is a water insoluble mineral, and has been found to act as a sensitizer in a thermite reaction. Without wishing to be bound by theory, it is believed that calcium fluoride acts, at least partly catalytically, to interrupt the oxide layer on aluminium metal. In some embodiments, the sensitizer may comprise magnesium fluoride (MgF₂).

It will be understood that the term “fluorine” as used herein is intended to refer to any compounds which contain fluorine in ionic or covalent form, e.g. in the form of fluoride. In the context of the present application, a “fluorine-free” product is a product that contains no fluorine, or only trace amounts of fluorine, irrespective of form, i.e. it is both fluorine- and fluoride-free.

The oxidant oxidises the oxidisable fuel as part of the thermite reaction. Although CaSO₄ may act as an oxidant as well as a sensitizer in the present invention, it will be understood that the term “oxidant” is used herein to refer to any oxidant present in the composition which is not CaSO₄. Suitable oxidants include iron oxide (Fe₂O₃, FeO and/or Fe₃O₄), ferrosilite (FeSiO₃), manganese dioxide (MnO₂), sodium nitrate (NaNO₃), potassium nitrate (KNO₃), sodium chlorate (NaClO₃), potassium chlorate (KClO₃), strontium sulphate (SrSO₄), barium sulphate (BaSO₄), titanium dioxide (TiO₂), copper oxide (CuO), naturally occurring minerals comprising these materials and combinations thereof.

In some embodiments, the oxidant comprises oxidants which are substantially insoluble in water. A material is considered to be substantially insoluble in water if it has a solubility in water of less than 0.5 g/100 ml at 20° C. Use of insoluble oxidants is advantageous since a refractory article may be prepared from the composition using an aqueous slurry of solid components, as well as being suitable for manufacture via a core-shot process. Oxidants that are substantially insoluble in water include iron oxide, manganese dioxide, copper oxide, strontium sulphate, barium sulphate and titanium dioxide.

In some embodiments, the oxidant comprises one or more oxidants selected from the group consisting of iron oxide (Fe₂O₄ and/or Fe₃O₄), ferrosilite (FeSiO₃), potassium nitrate (KNO₃), manganese dioxide (MnO₂), titanium dioxide (TiO₂) and copper oxide (CuO). In some embodiments, the oxidant comprises a combination of iron oxide (Fe₂O₄ and/or Fe₃O₄), ferrosilite (FeSiO₃) and potassium nitrate (KNO₃).

In some embodiments, the composition comprises at least 2 wt %, at least 5 wt %, at least 10 wt %, at least 12 wt %, at least 15 wt %, at least 20 wt % or at least 25 wt % oxidant. In some embodiments, the composition comprises no more than 30 wt %, no more than 25 wt %, no more than 20 wt %, no more than 15 wt %, no more than 12 wt % or no more than 10 wt % oxidant. In some embodiments, the composition comprises from 2 to 30 wt %, from 5 to 25 wt % or from 10 to 20 wt % oxidant.

In some embodiments, the oxidisable fuel comprises a metal. In some embodiments, the metal is selected from one or more of aluminium, magnesium, silicon, tin, zinc and alloys thereof, either individually or as mixtures. In some embodiments, the oxidisable fuel comprises aluminium and silicon metal. Providing a combination of different oxidisable metals having different reactivity may help to tune the characteristics of the thermite reaction (e.g. ignition time, burn time, maximum temperature, etc.) For example, without wishing to be bound by theory, the inventors of the present invention have found that silicon has a higher activation energy than aluminium but also a higher energy output, so providing a combination of silicon metal and aluminium as the oxidisable fuel may help to balance the characteristics of the thermite reaction in the absence of a fluoride sensitizer.

The oxidisable fuel may be in the form of a granular material (e.g. a fine powder, coarse powder, grindings or combinations thereof), a foil, skimmings, dross or combinations thereof. In some embodiments, the oxidisable fuel comprises a combination of metal foil and granular metal. In some embodiments, the oxidisable fuel comprises metal in the form of atomised powder, i.e. very fine powder. Oxidisable fuel in the form of atomised powder may be more reactive than other forms of oxidisable fuel. Providing the oxidisable fuel in a combination of different forms may also help to tune the characteristics of the thermite reaction and balance these characteristics in the absence of a fluoride sensitizer.

In some embodiments, the oxidisable fuel comprises an atomised powder and the atomised powder comprises atomised aluminium, atomised silicon or a combination thereof. In some embodiments, the atomised powder comprises at least 50 wt %, at least 60 wt %, at least 70 wt %, at least 80 wt %, at least 90 wt % or at least 95 wt % atomised aluminium. In some embodiments, the atomised powder comprises at least 2 wt %, at least 5 wt %, at least 10 wt %, at least 20 wt %, at least 30 wt % or at least 40 wt % atomised silicon. In some embodiments, the atomised powder comprises from 60 to 95 wt % atomised aluminium and from 5 to 40 wt % atomised silicon.

The atomised aluminium powder may have a D90 particle size of less than 150 μm, less than 140 μm, less than 130 μm, less than 120 μm, less than 110 μm or less than 100 μm, a D50 particle size of less than 80 μm, less than 70 μm, less than 60 μm, less than 50 μm or less than 40 μm, and/or a D10 particle size of less than 30 μm, less than 25 μm, less than 20 μm, less than 15 μm or less than 10 μm. In some embodiments, the oxidisable fuel comprises atomised aluminium powder having a D90 particle size of less than 130 μm, a D50 particle size of less than 60 μm and a D10 particle size of less than 20 μm.

The atomised silicon powder may have a D90 particle size of less than 65 μm, less than 55 μm, less than 45 μm, less than 35 μm or less than 25 μm. In some embodiments, the oxidisable fuel comprises atomised silicon having a D90 particle size of less than 45 μm.

In some embodiments, the oxidisable fuel comprises atomised aluminium having a D90 particle size of less than 130 μm and atomised silicon having a D90 particle size of less than 45 μm.

In some embodiments, the oxidisable fuel comprises at least 20 wt %, at least 30 wt %, at least 40 wt %, at least 50 wt %, at least 60 wt % or at least 70 wt % atomised powder. In some embodiments, the oxidisable fuel comprises no more than 80 wt %, no more than 70 wt %, no more than 60 wt %, no more than 50 wt % or no more than 40 wt % atomised powder. In some embodiments, the oxidisable fuel comprises from 20 to 80 wt %, from 30 to 70 wt % or from 40 to 60 wt % atomised powder. The exact proportion of atomised powder in the oxidisable fuel may depend on the type and proportions of different metals used. For example, if a low proportion or no silicon is used, a higher proportion of atomised aluminium may be required.

In some embodiments, the composition comprises at least 5 wt %, at least 10 wt %, at least 15 wt %, at least 20 wt % or at least 25 wt % oxidisable fuel. In some embodiments, the composition comprises no more than 30 wt %, no more than 25 wt %, no more than 20 wt %, no more than 15 wt % or no more than 10 wt % oxidisable fuel. In some embodiments, the composition comprises from 5 to 30 wt %, from 10 to 25 wt % or from 15 to 25 wt % oxidisable fuel.

The composition comprises particulate refractory material, which may act as a filler and provide insulating properties. The particulate refractory material may be in the form of a powder, granules, fibres or any combination thereof. In some embodiments, the particulate refractory material is selected from silica, olivine, alumina, aluminosilicates (including chamotte), pumice, magnesia, chromite, zircon, and combinations thereof.

Preferably, the composition comprises at least 30 wt %, at least 35 wt %, at least 40 wt %, at least 45 wt %, or at least 50 wt % of particulate refractory material. In some embodiments, the composition comprises no more than 70 wt %, no more than 65 wt %, no more than 60 wt %, no more than 55 wt %, or no more than 50 wt % of particulate refractory material.

Additionally or alternatively, the particulate refractory material may comprise a lightweight material having a density less than 1 g/cm3 or less than 0.5 g/cm3. Such lightweight materials are particularly useful for providing insulation. Suitable lightweight materials include perlite, diatomite, calcined rice husks (rice husk ash), refractory fibres, fly ash floaters (hollow microspheres), cenospheres, other natural or synthetic hollowspheres such as alumina, silica or aluminosilicate, and combinations thereof.

Suitable binders for use in the present invention include resins (e.g. phenol-formaldehyde resin or urea formaldehyde resin), gums (e.g. gum arabic or xanthan gum), sulphite lye, starches, acrylic dispersions, colloidal silica, colloidal alumina and combinations thereof. In some embodiments, the binder comprises a combination of resin and starch. In some embodiments, the binder may comprise more than one starch. In some embodiments, the one or more starches may comprise wheat starch, potato starch, maize starch, waxy maize starch, rice starch, soya starch, tapioca starch, modified starches, cationic starches, hot-swelling starches, and combinations thereof. In some embodiments, the one or more starches may be partially or fully pre-gelatinized. In one series of embodiments, the one or more starches comprises a combination of a non-pre-gelatinized starch and a pre-gelatinized starch, and preferably wherein both are wheat starch.

In a preferred series of embodiments, the binder is non-toxic and/or bio-degradable. Starches are particularly preferred since they break down easily and do not contaminate mould sands after use e.g. during reclamation of the mould sand the starches can simply be washed out without requiring subsequent specialist water treatment.

In some embodiments, the composition comprises from 0.5 to 5 wt %, or from 1 to 4 wt %, or from 1.5 to 3.5 wt % or from 2 to 3 wt % of binder.

In some embodiments, the composition further comprises a carrier fluid, such as water. Preferably, the composition comprises a carrier fluid in which the other components of the composition are not soluble, so that the composition may form a slurry of suspended solid components for making the refractory article.

According to a second aspect of the invention, there is provided a refractory article for use in a feeding system in metal casting. The refractory article is formed from a composition as described herein.

The refractory article may be produced by a variety of methods including slurry (vacuum forming) or core-shooting (blowing or ramming). The choice of binder may depend on the method by which the refractory article is manufactured.

In some embodiments, the refractory article is an exothermic refractory article. Refractory articles may include a number of products used in a foundry to assist in feeding a metal casting, such as feeder sleeves (also known as just “feeders” or “sleeves”) and other shaped articles that cover part of the casting or casting mould assembly (e.g. feeder boards, profiled cores, exothermic padding, and sleeve and core combinations).

In some embodiments, the refractory article is a feeder sleeve. The shape of the feeder sleeve is not particularly limited. The feeder sleeve may have a circular or an oval cross-section, it may have parallel or sloping sides and it may be open or closed. In an embodiment where the feeder sleeve is closed, it may have a domed or flat cover. The feeder sleeve may be cylindrical (i.e. having a circular cross-section and parallel sides) or frustoconical (i.e. having a circular cross-section and sloping sides).

In some embodiments, the refractory article is a feeder board, which may be in the form of jointed mats. The jointed mats may be wrapped around a feeder pattern or made up into a conventional feeder sleeve. Alternatively, the feeder board may be employed as a feeder lid to be placed upon an open feeder sleeve, with the shape of the board being determined by the shape of the feeder sleeve. Typically the feeder lid will have a circular or oval cross-section.

In some embodiments, the refractory article is a Williams core (also known as a Williams wedge). A Williams core is an article with a sharp pointed edge, typically being in the shape of a cone or wedge, which is located at the top of a closed sleeve to improve and stabilise the feeding effect. Williams cores may be formed integrally with a feeder sleeve or they may be produced separately and then fixed to the inside of a sleeve.

In some embodiments, the refractory article may comprise a combination of a sleeve component and a breaker core component that is in contact with the casting surface, with a profiled shape specifically designed to match the shape of the desired casting.

In some embodiments, the refractory article may comprise a profiled shape known as padding, whereby the exothermic nature of the padding can be used to extend the feeding distance of a sleeve, or to delay and or control the solidification time of the casting section beneath the padding. In one embodiment, the padding is used in combination with a sleeve component to form a single unit.

It will be understood that any of the optional features and embodiments described in relation to the first aspect may apply equally to the composition of the second aspect.

### Experimental Procedures

Standard cylindrical test bodies were prepared using the Georg Fischer (+GF+) method. Green (uncured) feeder sleeves were first produced using a slurry method. The green feeder sleeves were then chopped up and mixed using a flat blade paddle mixer until the components were fully mixed and the composition was uniform. A sample of the mixture was loosely packed into a cylindrical precision test body (50 mm internal diameter) and placed on the +GF+ sand rammer (type SPRA) and the mixture compressed via three ramming motions. After ensuring that the height was within the tolerance marks, the test bodies were removed using an ejector (stripping post). The test bodies were then hardened by placing them in a drying oven at 160° C. for 90 minutes. The resulting cylindrical test bodies had dimensions of 50 mm×50 mm.

The test bodies had the following general composition (based on solids content):
0.5 to 5 wt % calcium sulfate
0 to 2 wt % fluorine-based sensitizer
7 to 10 wt % iron oxide (Fe₃O₄) oxidant
10 to 20 wt % oxidant comprising potassium nitrate and ferrosilite
10 to 20 wt % aluminium
1 to 5 wt % silicon
0.5 to 5 wt % binders
40 to 60 wt % high density refractory fillers
0 to 5 wt % low density refractory fillers

The aluminium comprised a mixture of aluminium foil, powder and grindings. The silicon comprised an atomised silicon powder. The high density refractory fillers comprised a mixture of sand, chamotte, pumice and aluminosilicate materials, while the low density refractory fillers comprised cenospheres.

The proportion of high and low density refractory fillers was adjusted as appropriate to make up the balance of all components to a total of 100 wt %.

### Ignition Time and Burn Time

Using in-house test equipment (Amitec), the standard test body was placed on an electrically heated silicon carbide (SiC) plate, pre-heated and maintained at 1400° C. The ignition time was measured from the body being placed on the heating device until ignition (reported in seconds). As soon as ignition occurred, the test body was transferred to a sand bed where it was allowed to burn out. The burn time was measured as the period from ignition to end of burning (reported in seconds).

The desired ignition and burn time will vary depending on the application. A short ignition time is particularly useful for small feeder sleeves where it is essential to feed the casting very quickly. For larger feeder sleeves a longer burn time is useful since the casting can be fed for longer, and the ignition time is not so important.

### Maximum Temperature and Time Above 1150° C.

An Al₂O₃ protective tube was fitted to a green standard test body by pressing it into the exact centre of the body to a depth of 25 mm. The test body was then dried and a thermocouple was connected to a plotter inserted into the protective tube. The test body was ignited and the maximum temperature reached (Tₘₐₓ) was recorded by the plotter, as well as the time above 1150° C. (t>1150° C.).

In casting applications, the feeder sleeve only serves a useful purpose when the metal in the feeder is maintained as a liquid. The liquidus temperature of ferrous metals is in the region of 1150° C., and so t>1150° C. may provide a more accurate guide to a feeder sleeve's performance than the burn time.

### EXAMPLE 1

A series of test bodies were produced and tested as described above, using compositions comprising varying proportions of fluoride-based sensitizer. The test results are detailed in Table 1 below.

TABLE 1

| | | E1 | E2 | E3 |
|---|---|---|---|---|
| Sensitiser (wt %) | Calcium fluoride | 0.5 | 0.7 | 2.0 |
| | Calcium sulfate | 1.5 | 1.5 | 1.5 |
| Oxidant (wt %) | Iron oxide (Fe₃O₄) | 9.0 | 9.0 | 9.0 |
| | Potassium nitrate | 11.0 | 11.0 | 11.0 |
| | Ferrosilite | 5.0 | 5.0 | 5.0 |
| Oxidisable fuel | Aluminium (foil) | 8.5 | 8.5 | 8.5 |
| (wt %) | Aluminium (atomised) | 8.2 | 8.2 | 8.2 |
| | Silicon (atomised) | 2.0 | 2.0 | 2.0 |
| Refractory filler | High density | 50.9 | 50.7 | 49.4 |
| (wt %) | Low density | 0.5 | 0.5 | 0.5 |
| Binders (wt %) | Starch | 1.4 | 1.4 | 1.4 |
| | Resin | 1.5 | 1.5 | 1.5 |

| | | | |
|---|---|---|---|
| Ignition time (s) | 30 | 25 | 20 |
| Burn time (s) | 170 | 158 | 110 |
| Tmax, oxidation (° C.) | 1535 | 1539 | 1638 |
| t > 1150° C., oxidation (s) | 252 | 251 | 234 |
| Tmax, reduction (° C.) | 1439 | 1423 | 1519 |
| t > 1150° C., reduction (s) | 219 | 235 | 255 |

The results obtained demonstrate that compositions comprising calcium sulfate still achieve good exothermic performance even with lower levels of fluoride-based sensitizer. The test bodies made using low-fluoride compositions (E1 and E2) exhibited slightly longer ignition times and lower maximum temperatures, but also achieved significantly longer burn times and time above 1150° C. than the higher fluoride composition (E3).

### EXAMPLE 2

Another series of test bodies was evaluated using different low-fluoride compositions, comprising varying proportions of atomised aluminium powder and coarse granular aluminium. The results are detailed in Table 2 below.

TABLE 2

| | | E4 | E5 | E6 | E7 | E8 |
|---|---|---|---|---|---|---|
| Sensitiser (wt %) | Calcium fluoride | 0.7 | 0.7 | 0.7 | 0.7 | 0.7 |
| | Calcium sulfate | 1.6 | 1.6 | 1.6 | 1.6 | 1.6 |
| Oxidant (wt %) | Iron oxide (Fe₃O₄) | 8.9 | 8.9 | 8.9 | 8.9 | 8.9 |
| | Potassium nitrate | 10.8 | 10.8 | 10.8 | 10.8 | 10.8 |
| | Ferrosilite | 3.3 | 3.3 | 3.3 | 3.3 | 3.3 |
| Oxidisable fuel (wt %) | Aluminium (foil) | 8.5 | 8.5 | 8.5 | 8.5 | 8.5 |
| | Aluminium (grindings) | 0 | 2.05 | 4.10 | 6.15 | 8.20 |
| | Aluminium (atomised) | 8.20 | 6.15 | 4.10 | 2.05 | 0 |
| | Silicon (atomised) | 2.0 | 2.0 | 2.0 | 2.0 | 2.0 |
| Refractory filler (wt %) | High density | 52.7 | 52.7 | 52.7 | 52.7 | 52.7 |
| | Low density | 0.5 | 0.5 | 0.5 | 0.5 | 0.5 |
| Binders (wt %) | Starch | 1.3 | 1.3 | 1.3 | 1.3 | 1.3 |
| | Resin | 1.5 | 1.5 | 1.5 | 1.5 | 1.5 |

| | | | | | |
|---|---|---|---|---|---|
| Ignition time (s) | 35 | 30 | 30 | 40 | 40 |
| Burn time (s) | 225 | 215 | 212 | 180 | 180 |
| Tmax, oxidation (° C.) | 1522 | 1516 | 1504 | 1520 | 1558 |
| t > 1150° C., oxidation (s) | 263 | 269 | 253 | 261 | 245 |
| Tmax, reduction (° C.) | 1341 | 1377 | 1195 | 1431 | 1306 |
| t > 1150° C., reduction (s) | 168 | 248 | 72 | 242 | 171 |

The results obtained demonstrate how the reaction characteristics of a low-fluoride refractory article can be tuned by altering the proportion of finer (more reactive) aluminium and coarser (less reactive) aluminium. In general, the low-fluoride compositions containing higher proportions of atomised aluminium powder were found to exhibit shorter ignition times and longer burn times than the compositions containing lower proportions of atomised aluminium powder.

### EXAMPLE 3

Feeder sleeves in accordance with the present invention (E9, E10 and E11) were compared with a commercially available exothermic feeder sleeve (C1), made using the following compositions:

TABLE 3

| | | E1 | E2 | E3 | C1 |
|---|---|---|---|---|---|
| Sensitiser (wt %) | Calcium fluoride | 0.4 | 0.5 | 0.6 | 1.9 |
| | Calcium sulfate | 1.4 | 1.4 | 1.6 | 0 |
| Oxidant (wt %) | Iron oxide (Fe₃O₄) | 9.4 | 8.5 | 8.5 | 5.2 |
| | Potassium nitrate | 9.4 | 9.4 | 10.4 | 9.2 |
| | Ferrosilite | 3.1 | 4.7 | 3.2 | 3.2 |
| Oxidisable Fuel | Aluminium | 15.5 | 17.0 | 16.0 | 27.0 |
| (wt %) | Silicon | 3.3 | 3.3 | 1.9 | 0 |
| Refractory Filler | High density | 47.6 | 49.7 | 48.9 | 41.6 |
| (wt %) | Low density | 1.9 | 0.5 | 0.5 | 2.5 |
| Binder (wt %) | Starch | 1.9 | 0 | 1.3 | 1.8 |
| | Resin | 0 | 0 | 1.5 | 2.0 |
| | Xanthan gum | 0.9 | 1.0 | 0 | 0 |
| Carrier Fluid | Water | 5.2 | 4.0 | 5.5 | 5.6 |
| (wt %) | | | | | |

The example feeder sleeves made using compositions E1-E3 were found to exhibit similar feeding performance to the commercial feeder sleeve C1, but with significantly less fluorine-based sensitizer in the composition. The inventors have further found that the water insolubility of the calcium fluoride used means that there is no contamination issue during reclamation of mould sand after a metal casting process has been carried out. In combination with the use of biodegradable binders, such as starch and xanthan gum, the environmental characteristics of the example feeder sleeves are greatly improved compared with the commercial feeder sleeve.

1. A composition for making a refractory article for use in a feeding system in metal casting, the composition comprising:
a particulate refractory material;
an oxidisable fuel;
an oxidant;
a sensitizer; and
a binder,
wherein the composition comprises from 0.5 to 5 wt % CaSO₄.

2. The composition of claim 1, wherein the composition comprises less than 2.0 wt % fluorine, or wherein the composition is substantially fluorine-free.

3. The composition according to any one of the preceding claims, wherein the sensitizer comprises a fluorine compound which is insoluble in water.

4. The composition according to claim 3, wherein the fluorine compound is calcium fluoride (CaF₂).

5. The composition of any one of the preceding claims, wherein the oxidant comprises one or more oxidants selected from the group consisting of: iron oxide (Fe₂O₄ and/or Fe₃O₄), ferrosilite (FeSiO₃), potassium nitrate (KNO₃), manganese dioxide (MnO₂), titanium dioxide (TiO₂) and copper oxide (CuO).

6. The composition of any one of the preceding claims, wherein the composition comprises from 2 to 30 wt % oxidant.

7. The composition of any one of the preceding claims, wherein the oxidisable fuel comprises a metal, and optionally wherein the oxidisable fuel is aluminium, and optionally wherein the oxidisable fuel comprises aluminium foil and/or granular aluminium.

8. The composition of any one of the preceding claims, wherein the oxidisable fuel comprises silicon metal.

9. The composition of any one of the preceding claims, wherein the composition comprises:
i) at least 10 wt % oxidisable fuel; and/or
ii) no more than 30 wt % oxidisable fuel.

10. The composition of any one of the preceding claims, wherein the oxidisable fuel comprises an atomised powder, optionally wherein the atomised powder comprises atomised aluminium and/or atomised silicon metal.

11. The composition of claim 10, wherein the atomised powder comprises at least 60 wt % atomised aluminium.

12. The composition of claim 10 or claim 11, wherein the atomised powder comprises at least 10 wt % atomised silicon metal.

13. The composition of any one of claims 10 to 12, wherein the oxidisable fuel comprises at least 30 wt % atomised powder.

14. The composition of any one of the preceding claims, further comprising a carrier fluid, optionally wherein the carrier fluid is water.

15. A refractory article for use in a feeding system in metal casting, wherein the article is formed from a composition according to any one of the preceding claims.

16. The refractory article of claim 15, wherein the refractory article is a feeder sleeve.
